(19) United States
(12) Patent Application Publication
(10) Pub. No.: US 2023/0223714 A1
(43) Pub. Date: Jul. 13, 2023

(54) SPRING LEAF, CONNECTION TERMINAL, AND ELECTRICAL CONNECTOR

(71) Applicant: Xuancheng Luxshare Precision Industry Co.,Ltd, Xuancheng City (CN)

(72) Inventors: Shuguang CHEN, Xuancheng City (CN); Rongxin SHEN, Xuancheng City (CN); Wei GAO, Xuancheng City (CN); Qi YANG, Xuancheng City (CN); Chongyang ZHONG, Xuancheng City (CN); Guangyu XI, Xuancheng City (CN)

(73) Assignee: Xuancheng Luxshare Precision Industry Co.,Ltd, Xuancheng City (CN)

(21) Appl. No.: 18/094,635

(22) Filed: Jan. 9, 2023

(30) Foreign Application Priority Data
Jan. 13, 2022 (CN) 202220090305.6

(51) Int. Cl. H01R 13/187

(52) U.S. Cl. CPC H01R 13/187

(57) ABSTRACT

The embodiments of the present utility model provide a spring leaf, a connection terminal, and an electrical connector, where the spring leaf is provided in a cylindrical housing in a winding manner, and extends outward from a first end to form hangers extending out of the housing. The spring leaf is hung on an end portion of the housing through the hangers, and then the hangers are fixed through an end cover arranged at the end portion of the housing. Thus, the first end of the spring leaf may be fixed through the hangers, and a second end of the spring leaf may move automatically. When a pin is inserted, the compressed spring leaf will not be dislocated, which ensures the contact reliability of the pin with the spring leaf.

### CLAIM OF PRIORITY AND CROSS-REFERENCE TO RELATED APPLICATION(S)

This application claims the benefit of Chinese Patent Application No. 202220090305.6, filed on Jan. 13, 2022, which is incorporated herein by reference in its entirety.

### BACKGROUND OF THE DISCLOSURE

### 1. Field of the Disclosure

The present utility model relates to the field of electrical connectors, and in particular to a spring leaf, a connection terminal, and an electrical connector.

### 2. Description of the Related Art

In vehicle, aerospace, military, 3C product and other industries, especially in a new energy vehicle industry, an electrical connector is an essential connection device in the high voltage and high current transmission line. As a core component in the electrical connector, a connection terminal plays a decisive role in the safety of circuits. In an existing connection terminal, both ends of a spring leaf are limited, leading to a problem of abnormal contact caused by dislocation of the spring leaf after insertion of a pin.

### BRIEF DESCRIPTION OF THE DISCLOSURE

In view of this, a purpose of the present utility model is to provide a spring leaf, a connection terminal, and an electrical connector. The spring leaf is fixed on a housing through a first end having hangers, and when the spring leaf is compressed, a second end may move freely, so that the spring leaf will not be dislocated, and a problem of abnormal contact is avoided.

According to a first aspect, the embodiments of the present utility model provide a spring leaf, the spring leaf including:

a first end piece wound in a ring shape and located at a first end of the spring leaf;

a second end piece wound in a ring shape and located at a second end of the spring leaf; and

a plurality of strip-shaped connection arms connected between the first end piece and the second end piece,

where an edge of the first end piece extends outwardly to form hangers for hanging the spring leaf on an end portion of a housing.

Further, the connection arms are provided in an H shape, and a middle portion thereof protrudes inwardly; and

a central region of the middle portion of the connection arms extends outwardly to form branch pieces.

Further, the edge of the first end piece extends radially outwardly to form a plurality of hangers distributed at intervals;

an edge of the second end piece extends in an axial direction to form a plurality of protrusions.

Further, the spring leaf is provided with a gap arranged in the axial direction, and the gap is used for adjusting a winding size of the spring leaf.

According to a second aspect, the embodiments of the present utility model further provide a connection terminal, the connection terminal including:

a housing provided in a cylindrical shape;

at least one spring leaf according to the first aspect, where the spring leaf is provided in the housing in a winding manner, one end of the spring leaf is hung on an end portion of the housing through the hangers, and the other end of the spring leaf is movably provided in the housing; and

at least one end cover provided at the end portion of the housing to fix the hangers to the end portion of the housing.

Further, the housing has a dovetail joint structure; and

the housing is fastened by means of the dovetail joint structure.

Further, the end portion of the housing has an annular groove arranged on an outer side of the housing; and

the end cover is fixed by means of the annular groove in a riveted manner.

Further, the end cover includes:

a bottom plate provided as an annular structure, and the bottom plate is pressed on the hangers;

a first side wall formed by an inner edge of the bottom plate extending towards a second end of the spring leaf, where a size of the first side wall matches that of a first end of the spring leaf; and

a second side wall formed by an outer edge of the bottom plate extending towards a second end of the spring leaf, where a size of the second side wall matches that of the annular groove.

Further, one spring leaf and one end cover are fixed at both ends of the housing.

Further, one spring leaf and one end cover are fixed at one end of the housing; and

the other end of the housing extends in the axial direction to form a tail piece, and the tail piece is configured to rivet a wire.

According to a third aspect, the embodiments of the present utility model further provide an electrical connector, the electrical connector including:

the connection terminal according to the second aspect.

The embodiments of the present utility model provide a spring leaf and a connection terminal. The spring leaf is provided in a cylindrical housing in a winding manner, and extends outwardly from a first end to form hangers extending out of the housing. The spring leaf is hung on an end portion of the housing through the hangers, and then the hangers are fixed through an end cover arranged at the end portion of the housing. Thus, the first end of the spring leaf may be fixed through the hangers, and a second end of the spring leaf may move automatically. When a pin is inserted, the compressed spring leaf will not be dislocated, which ensures the contact reliability of the pin with the spring leaf.

### BRIEF DESCRIPTION OF THE DRAWINGS

The above and other purposes, features, and advantages of the present utility model will be more apparent from the following description of the embodiments of the present utility model with reference to the accompanying drawings. In the drawings:

FIG. 1 is a schematic structural diagram of a connection terminal according to an embodiment of the present utility model;

FIG. 2 is a schematic cross-sectional diagram of a connection terminal according to an embodiment of the present utility model;

FIG. 3 is an enlarged schematic diagram of a spring leaf mounting structure according to an embodiment of the present utility model;

FIG. 4 is a schematic structural diagram of a spring leaf according to an embodiment of the present utility model;

FIG. 5 is a schematic diagram showing positions of a spring leaf and a housing according to an embodiment of the present utility model;

FIG. 6 is a schematic structural diagram of a housing according to an embodiment of the present utility model;

FIG. 7 is a schematic structural diagram of an end cover according to an embodiment of the present utility model;

FIG. 8 is a schematic structural diagram of another connection terminal according to an embodiment of the present utility model; and

FIG. 9 is a schematic structural diagram of a connection terminal in the related art.

### DETAILED DESCRIPTION OF EMBODIMENTS OF THE DISCLOSURE

The present utility model is described below based on the embodiments, but the present utility model is not limited to these embodiments. In the following detailed description of the utility model, some specific details are described in detail. The present utility model may be fully understood by those skilled in the art without the description of these details. In order to avoid obscuring the spirit of the present utility model, well-known methods, processes, procedures, elements, and circuits are not described in detail.

In addition, those of ordinary skill in the art should understand that the drawings provided herein are for illustrative purposes and are not necessarily drawn to scale.

Unless expressly required in the context, the terms “include”, “comprise”, and other similar words should be construed as inclusive rather than exclusive or exhaustive, that is, the meaning of “including, but not limited to”.

In the description of the present utility model, it should be understood that the terms “first”, “second”, and the like are used for descriptive purposes only and may not be construed as indicating or implying relative importance. In addition, in the description of the present utility model, the term “a plurality of” means two or more, unless otherwise stated.

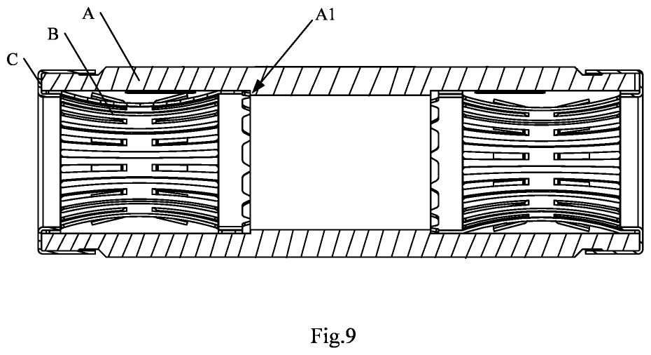

FIG. 9 is a schematic structural diagram of a connection terminal in the related art. As shown in FIG. 9, in the related art, an inner wall of a shell A of the connection terminal has a stop structure A1, and both ends of a hanger-free spring leaf B are limited by the stop structure A1 and a top cover C. When a pin is inserted into the connection terminal in the related art, the hanger-free spring leaf B is compressed while both ends are pressed against and cannot be moved, and a simply supported beam formed in the shell A by the hanger-free spring leaf B is easily dislocated, so as to affect the contact reliability of the pin with the hanger-free spring leaf B.

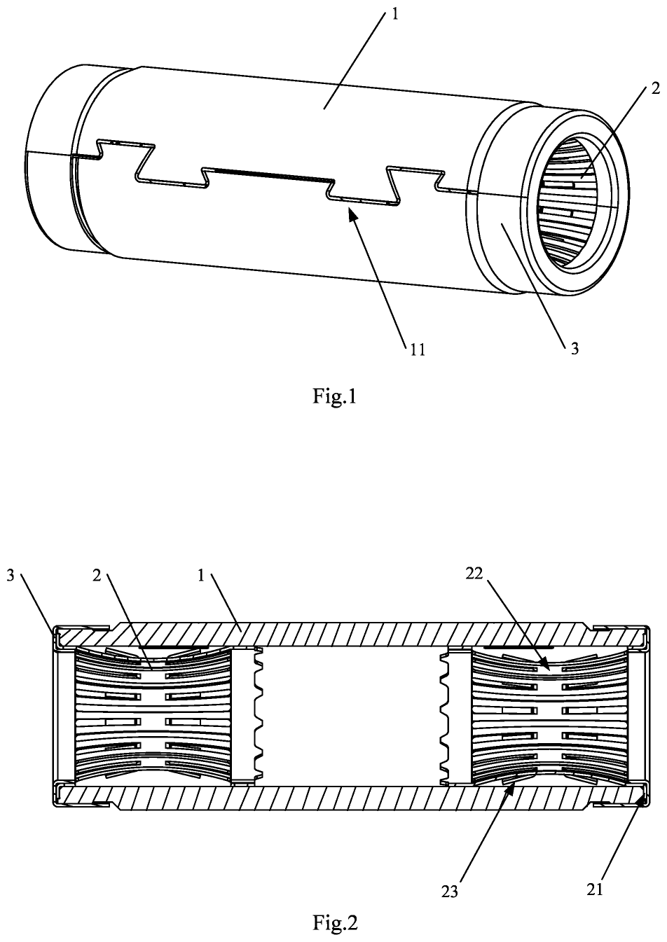

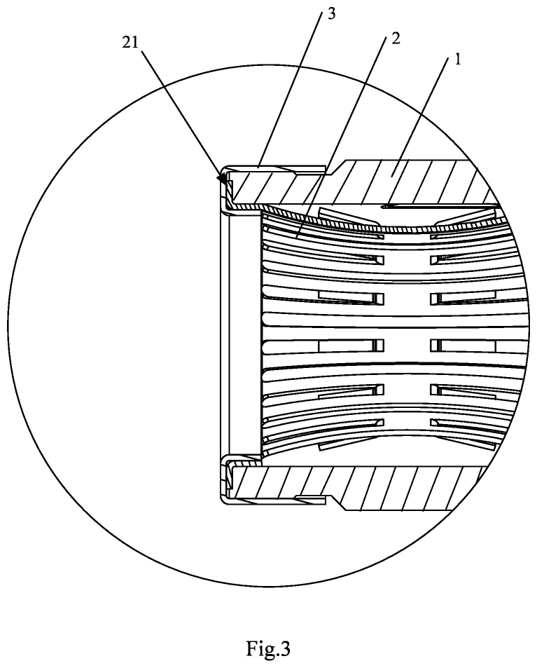

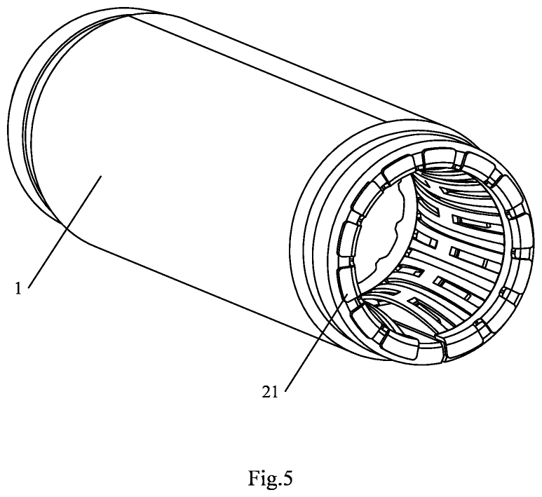

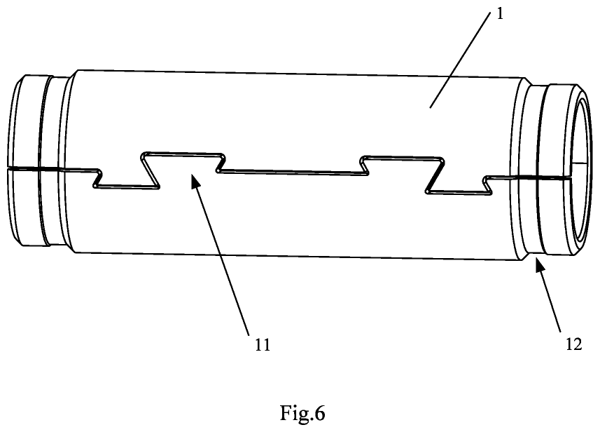

FIG. 1 is a schematic structural diagram of a connection terminal according to an embodiment of the present utility model. FIG. 2 is a schematic cross-sectional diagram of a connection terminal according to an embodiment of the present utility model. As shown in FIGS. 1 and 2, the connection terminal includes a housing 1, at least one spring leaf 2, and at least one end cover 3, wherein the housing 1 is provided in a cylindrical shape, and the spring leaf 2 is provided in the housing 1 in a winding manner, so that the connection terminal is formed as an insertion hole into which a pin may be inserted. It should be noted that, as an optional implementation, the housing 1 is made of copper or other metallic materials, and the spring leaf 2 is made of beryllium bronze or other metallic materials. Further, with reference to what are shown in FIGS. 3 to 5, the spring leaf 2 extends outwardly from a first end 2a to form hangers 21 extending out of the housing 1, and the spring leaf 2 is hung on an end portion of the housing 1 through the hangers 21. In an implementation, the hangers 21 include a plurality of plate members distributed at intervals, so as to fit an annular end surface of the housing 1. In this embodiment, the first end 2a of the spring leaf 2 may be relatively fixed to the end portion of the housing 1 through the hangers 21, and a second end 2b of the spring leaf 2 does not need to be fixed by arranging a stop structure in the housing 1. Thus, the first end 2a of the spring leaf 2 is fixed by the hangers 21, and the second end 2b moves freely. When a pin is inserted, one end of the spring leaf 2 is fixed and the other end is free to move without forming a simply supported beam, so that the compressed spring leaf 2 will not be dislocated, which ensures the contact reliability of the pin with the spring leaf 2.

Furthermore, the end cover 3 is provided in the end portion of the housing 1, so that the hangers 21 fit on the annular end surface of the housing 1, that is, the end cover 3 fixes the hangers 21 to the end portion of the housing 1. It should be noted that in this implementation, after the end portion of the housing 1 is provided with the end cover 3, the two are fixed by rotary riveting, so that the hangers 21 closely fit the annular end surface of the housing 1, thereby fixing the first end 2a of the spring leaf 2 to the end portion of the housing 1.

In an implementation, the spring leaf 2 includes a first end piece 201 at the first end 2a and a second end piece 202 at the second end 2b, wherein the first end piece 201 and the second end piece 202 are wound into a ring shape of the same specification. Further, an edge of the first end piece 201 extends radially outwardly to form a plurality of hangers 21 distributed at intervals, and the plurality of hangers 21 ensure the reliability of connection between the spring leaf 2 and the housing 1. As an optional implementation, an edge of the second end piece 202 extends in an axial direction to form a plurality of protrusions 24, which helps to enhance the reliability of electrical connection.

In an implementation, a plurality of strip-shaped connection arms 22 are provided between the first end piece 201 and the second end piece 202. Further, the connection arms 22 are provided in an H shape, and a middle portion thereof protrudes inwardly. Thus, when a cylindrical pin is inserted into the connection terminal from the end portion of the housing 1, the pin abuts against the middle portion of the connection arms 22, so that the spring leaf 2 is compressed outwardly. At the same time, the first end 2a of the spring leaf 2 is fixed through the hangers 21, and the second end 2b moves in a direction away from the first end 2a under the action of the pin, which avoids a problem that the spring leaf 2 is dislocated after being compressed. In addition, the H-shaped connection arms 22 generate a large contact force, and the spring leaf 2 ensures the reliability of contact with the pin after being compressed by means of an elastic force.

In an implementation, a central region of the middle portion of the connection arms 22 extends outwardly to form branch pieces 23. It should be noted that the number and the position of the branch pieces 23 may be set based on a size of the housing 1, an elastic condition of the spring leaf 2, etc. Specifically, in this implementation, two branch pieces 23 are formed on each connection arm 22. The two branch pieces 23 extend obliquely outwardly from the central region of the middle portion of the connection arm 22 towards the first end 2a and the second end 2b of the spring leaf 2, respectively. Thus, when the spring leaf 2 is compressed by the insertion of the pin, the middle portion of the connection arms 22 moves outwardly, so that the branch pieces 23 abut against the inner wall of the housing 1 to ensure the reliability of contact of the pin with the spring leaf 2.

With reference to what are shown in FIGS. 1 and 6, in an implementation, the housing 1 has a dovetail joint structure 11. Specifically, the housing 1 is made by using a stamping and rolling process, and is fastened by means of the dovetail joint structure 11. When the pin is inserted into the connection terminal, the spring leaf 2 is compressed by an acting force of the pin while applying an outward acting force to the housing 1. When the housing 1 is subjected to the outward acting force from the spring leaf 2, the dovetail joint structure 11 functions to prevent the housing 1 from being disengaged.

In an implementation, the end portion of the housing 1 has an annular groove 12 provided on the outer side of the housing 1. Further, the end cover 3 needs to be rotated and riveted to be fixed to the end portion of the housing 1, and the annular groove 12 is configured to position and rivet the end cover 3. Thus, after the end cover 3 is fixed to the end portion of the housing 1, the hangers 21 of the spring leaf 2 may be pressed against the annular end surface of the housing 1, thereby fixing the first end 2a of the spring leaf 2 to the end portion of the housing 1.

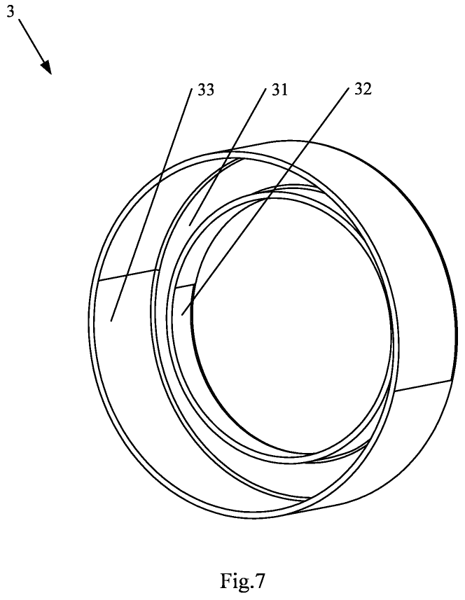

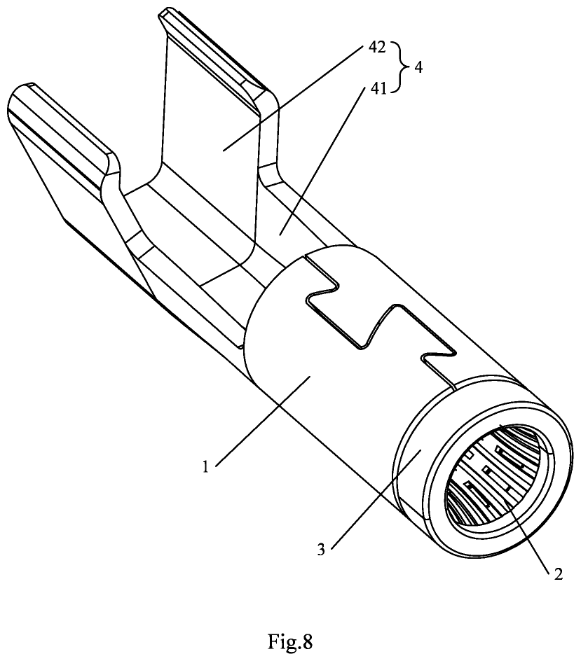

Furthermore, as shown in FIG. 7, the end cover 3 includes a bottom plate 31, a first side wall 32, and a second side wall 33, where the bottom plate 31 is provided in an annular structure corresponding to the annular end surface of the housing 1. When the end cover 3 is provided at the end portion of the housing 1, the bottom plate 31 is pressed on the hangers 21, thereby pressing the hangers 21 against the annular end surface of the housing 1. The first side wall 32 is formed by an inner edge of the bottom plate 31 extending towards the second end 2b of the spring leaf 2, and a size of the first side wall 32 matches that of the first end 2a of the spring leaf 2. When the end cover 3 is provided at the end portion of the housing 1, the end cover 3 presses the first end 2a of the spring leaf 2 against the inner wall of the housing 1 through the first side wall 32. The second side wall 33 is formed by an outer edge of the bottom plate 31 extending towards the second end 2b of the spring leaf 2, and a size of the second side wall 33 matches that of the annular groove. When the end cover 3 is provided at the end portion of the housing 1, the end cover 3 cooperates with the annular groove 12 through the second side wall 33 to implement rotary riveting.

As shown in FIG. 1, in an implementation, one spring leaf 2 and one end cover 3 are fixed at both ends of the housing 1. Specifically, the two spring leaves 2 are respectively hung on the end portions of the housing 1 from the two ends of the housing 1, and the two end covers 3 respectively fix the spring leaves 2 from the two ends of the housing 1. Thus, in this implementation, both ends of the connection terminal may be inserted with a pin.

As shown in FIG. 8, in another implementation, one spring leaf 2 and one end cover 3 are fixed at one end of a housing 1, and the other end of the housing 1 extends in an axial direction to form a tail piece 4. Specifically, the spring leaf 2 is hung at one end of the housing 1 and then fixed through the end cover 3, and a pin may be inserted into a connection terminal from this end of the housing 1. The other end of the housing 1 implements the function of riveting a wire through the integrally formed tail piece 4.

Further, the tail piece 4 includes a support portion 41 extending from the housing 1, and a riveting portion 42 extending from the support portion 41, where the support portion 41 is a U-shaped groove extending from an annular end surface of the housing 1, and functions to support the riveting portion 42 and bear a wire, and the riveting portion 42 is a U-shaped clamping plate extending from a U-shaped end surface of the support portion 41, and a tail end of the clamping plate inclines inwardly, and the riveting portion 42 functions to rivet a wire.

According to the connection terminal provided by the embodiments of the present utility model, the spring leaf 2 having the hangers 21 at the first end 2a is hung on the end portion of the housing 1, and fixed by the end cover 3 simultaneously, so that the second end 2b of the spring leaf 2 may move freely when a pin is inserted into the connection terminal, thereby ensuring that the spring leaf 2 will not be dislocated due to extrusion, and avoiding a problem of abnormal contact between the pin and the spring leaf 2.

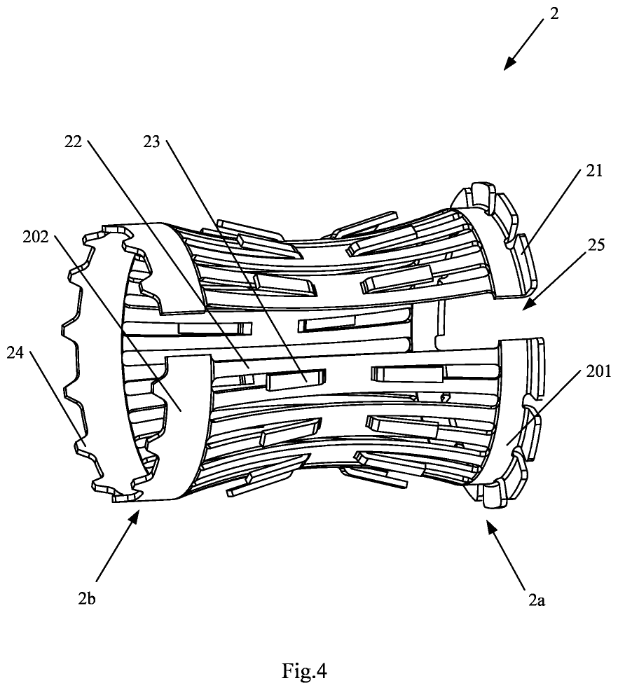

FIG. 4 is a schematic structural diagram of a spring leaf 2 according to an embodiment of the present utility model. As shown in FIG. 4, the embodiments of the present utility model further provide a spring leaf 2 arranged in a winding manner, and a first end 2a of the spring leaf 2 extends outwardly to form hangers 21. When the spring leaf 2 is arranged inside a housing 1 from one end of the housing 1, the hangers 21 fit on an annular end surface of the housing 1, so that the spring leaf 2 is hung on an end portion of the housing 1. Thus, the spring leaf 2 may be fixed inside the housing 1 through the hangers 21 at the first end 2a, a second end 2b of the spring leaf 2 may move freely, and the spring leaf 2 will not be dislocated when being compressed by the insertion of a pin, thereby ensuring the reliability of contact between the pin and the spring leaf 2. As an optional implementation, the material of the spring leaf 2 is beryllium bronze having a very high elastic limit, fatigue limit and a good electrical conductivity. It should be noted that the spring leaf 2 may also be made of other materials having the same characteristics.

In an implementation, the spring leaf 2 includes a first end piece 201 at the first end 2a and a second end piece 202 at the second end 2b, where the first end piece 201 and the second end piece 202 are wound into a ring shape of the same specification. Further, an edge of the first end piece 201 extends radially outwardly to form the plurality of hangers 21 distributed at intervals, and the plurality of hangers 21 ensure the reliability of connection between the spring leaf 2 and the housing 1. As an optional implementation, an edge of the second end piece 202 extends in an axial direction to form a plurality of protrusions 24, which helps to enhance the reliability of electrical connection.

In an implementation, a plurality of strip-shaped connection arms 22 are provided between the first end piece 201 and the second end piece 202, and the connection arms 22 are provided in an H shape, and a middle portion thereof protrudes inwardly. The connection arms 22 protruding inwardly cause the spring leaf 2 to be compressed outwardly under the action of the pin, so that the spring leaf 2 enhances the reliability of contact with the pin through an elastic force. At the same time, the H-shaped connection arms 22 may further increase a contact force between the spring leaf 2 and the pin.

In an implementation, a central region of the middle portion of the connection arms 22 extends outwardly to form branch pieces 23. It should be noted that the number and the position of the branch pieces 23 may be set based on a size of the housing 1, an elastic condition of the spring leaf 2, etc. Specifically, in this implementation, two branch pieces 23 are formed on each connection arm 22. The two branch pieces 23 extend obliquely outwardly from the central region of the middle portion of the connection arm 22 towards the first end 2a and the second end 2b of the spring leaf 2, respectively. Thus, when the spring leaf 2 is compressed by the insertion of the pin, the middle portion of the connection arms 22 moves outwardly, so that the branch pieces 23 abut against the inner wall of the housing 1 to ensure the reliability of contact of the pin with the spring leaf 2. In an implementation, the spring leaf 2 has a gap 25 arranged in the axial direction. It is easy to understand that in order to adapt to electrical connectors or connection terminals of different specifications, the spring leaf 2 needs to be wound in different sizes so as to be arranged inside housings 1 of different sizes. The gap 25 facilitates adjusting a winding size of the spring leaf 2, so that a use range of the spring leaf 2 may be expanded.

The spring leaf 2 provided by the embodiments of the present utility model is provide with the hangers 21 at the first end 2a, so that the spring leaf 2 may be directly fixed to one end of the housing 1 through the hangers 21, so that the second end 2b may move freely in the housing 1. Thus, when the pin is inserted into the connection terminal having the spring leaf 2, the spring leaf 2 will not be dislocated due to extrusion at both ends, so that the contact reliability of the pin with the spring leaf 2 may be ensured.

The embodiments of the present utility model further provide an electrical connector including a connection terminal, where a structure of the connection terminal is as described above, and details are not described herein again. The electrical connector may be applied to products in the vehicle, aerospace, military, 3C, and other industries. A spring leaf 2 having hangers 21 is hung on a housing 1, so that the spring leaf 2 will not be dislocated when a pin is inserted into the connection terminal, which ensures the contact reliability of the pin with the spring leaf 2 and helps to improve the product quality of the electrical connector.

The embodiments of the present utility model provide a spring leaf, a connection terminal, and an electrical connector, where the spring leaf is provided in a cylindrical housing in a winding manner, and extends outward from a first end to form hangers extending out of the housing. The spring leaf is hung on an end portion of the housing through the hangers, and then the hangers are fixed through an end cover arranged at the end portion of the housing. Thus, the first end of the spring leaf may be fixed through the hangers, and a second end of the spring leaf may move automatically. When a pin is inserted, the compressed spring leaf will not be dislocated, which ensures the contact reliability of the pin with the spring leaf.

The above description shows merely preferred embodiments of the present utility model, and is not intended to limit the present utility model. For those skilled in the art, various modifications and changes may be made to the present utility model. Any modifications, equivalents, improvements, etc. made within the spirit and principle of the present utility model may fall within the protection scope of the present utility model.

I/we claim:

1. A spring leaf, the spring leaf (2) comprising:
a first end piece (201) wound in a ring shape and located at a first end (2a) of the spring leaf (2);
a second end piece (202) wound in a ring shape and located at a second end (2b) of the spring leaf (2); and
a plurality of strip-shaped connection arms (22) connected between the first end piece (201) and the second end piece (202),
wherein an edge of the first end piece (201) extends outwardly to form hangers (21), and the hangers (21) are configured to hang the spring leaf (2) on an end portion of a housing (1).

2. The spring leaf according to claim 1, wherein the connection arms (22) are provided in an H shape, and a middle portion thereof protrudes inwardly; and
a central region of the middle portion of the connection arms (22) extends outwardly to form branch pieces (23).

3. The spring leaf according to claim 2, wherein the edge of the first end piece (201) extends radially outwardly to form a plurality of hangers (21) distributed at intervals; and
an edge of the second end piece (202) extends in an axial direction to form a plurality of protrusions (24).

4. The spring leaf according to claim 1, wherein the spring leaf (2) is provided with a gap (25) arranged in the axial direction, and the gap (25) is used for adjusting a winding size of the spring leaf (2).

5. A connection terminal, the connection terminal comprising:
a housing (1) provided in a cylindrical shape;
at least one spring leaf (2) according to claim 1, wherein the spring leaf (2) is provided in the housing (1) in a winding manner, one end of the spring leaf (2) is hung on an end portion of the housing (1) through the hangers (21), and the other end of the spring leaf (2) is movably provided in the housing (1); and
at least one end cover (3) provided at the end portion of the housing (1) to fix the hangers (21) to the end portion of the housing (1).

6. The connection terminal according to claim 5, wherein the housing (1) has a dovetail joint structure (11); and
the housing (1) is fastened by means of the dovetail joint structure (11).

7. The connection terminal according to claim 5, wherein the end portion of the housing (1) has an annular groove (12) arranged on an outer side of the housing (1); and
the end cover (3) is fixed by means of the annular groove (12) in a riveted manner.

8. The connection terminal according to claim 7, wherein the end cover (3) comprises:
a bottom plate (31) provided as an annular structure, wherein the bottom plate (31) is pressed on the hangers (21);
a first side wall (32) formed by an inner edge of the bottom plate (31) extending towards a second end (2b) of the spring leaf (2), wherein a size of the first side wall (32) matches that of a first end (2a) of the spring leaf (2); and
a second side wall (33) formed by an outer edge of the bottom plate (31) extending towards a second end (2b) of the spring leaf (2), wherein a size of the second side wall (33) matches that of the annular groove (12).

9. The connection terminal according to claim 5, wherein one spring leaf (2) and one end cover (3) are fixed at both ends of the housing (1).

10. The connection terminal according to claim 5, wherein one spring leaf (2) and one end cover (3) are fixed at one end of the housing (1); and
the other end of the housing (1) extends in the axial direction to form a tail piece (4), and the tail piece (4) configured to rivet a wire.

11. An electrical connector, the electrical connector comprising:
the connection terminal according to claim 5.
